(19) United States
(12) Patent Application Publication
(10) Pub. No.: US 2022/0250212 A1
(43) Pub. Date: Aug. 11, 2022

(54) RESISTING STRUCTURE OF RATCHET WRENCH

(71) Applicant: Chia-Yu CHEN, Taichung City (TW)

(72) Inventor: Chia-Yu CHEN, Taichung City (TW)

(21) Appl. No.: 17/171,387

(22) Filed: Feb. 9, 2021

(51) Int. Cl. B25B 13/46

(52) U.S. Cl. CPC B25B 13/463

(57) ABSTRACT

A resisting structure of ratchet wrench includes a ratchet wheel having a ratchet toothed portion fitting an outer periphery thereof, an engagement unit having an engagement toothed portion meshing with the ratchet toothed portion, a changeover groove, and a curved surface portion disposed on two sides of the changeover groove, and a changeover unit having an assembling portion disposed on a front side of the changeover unit and situated correspondingly to the changeover groove and a support portion disposed on two sides of the assembling portion and situated correspondingly to the curved surface portion. When the ratchet wheel moves back against a direction of applied force, the support portion of the changeover unit can limit a downward distance caused when the curved surface portion is pressed downwards to thereby ensure each moving back angle of the ratchet wheel.

### BACKGROUND OF THIS INVENTION

### 1. Field of this Invention

This invention relates to a hand tool and relates particularly to a resisting structure of ratchet wrench capable of ensuring an idling angle.

### 2. Description of the Related Art

Ratchet wrench is a hand tool generally used to rotate fasteners such as bolts or nuts or sockets, and it can rotate fasteners at a small angle. Referring to FIG. 1, a conventional ratchet wrench 10 is disclosed. The ratchet wrench 10 includes a main body 11, a ratchet wheel head 12, a ratchet toothed block 13, and a changeover unit 14. The main body 11 has an accommodating groove 111 disposed inside the main body 11 for accommodating the ratchet wheel head 12, the ratchet toothed block 13, and the changeover unit 14 in sequence. The changeover unit 14 can change a direction by an outer force. The changeover unit 14 has a pressing unit 141 provided with elasticity. The pressing unit 141 is capable of pressing the ratchet toothed block 13 elastically. Through changing a direction of the changeover unit 14 to further change an elastic position of the pressing unit 141, the ratchet toothed block 13 can mesh with the ratchet wheel head 12 at different position. A rotating direction of the ratchet wheel head 12 can be changed by changing a meshing position of the ratchet toothed block 13 to allow the ratchet wheel head 12 to apply force toward a single direction and to form idling and back moving toward another direction. In order to allow the ratchet wheel head 12 to move back toward a direction opposite to a direction of applied force, a space is provided between the ratchet toothed block 13 and the changeover unit 14 to allow the ratchet wheel head 12 to press the ratchet toothed block 13 and the pressing unit 141 downwards when the ratchet wheel head 12 moves back. Thus, the ratchet toothed block 13 will not mesh with the ratchet wheel head 12. Moreover, the elasticity generated by the pressing unit 141 will push the ratchet toothed block 13 again to limit each rotating angle of the ratchet wheel head 12, in other words, to limit an idling angle of each tooth. For instance, if the ratchet toothed head 12 has 72 teeth, it will move back for 5 degrees each time.

However, because the conventional ratchet wrench 10 keeps a space between the ratchet toothed block 13 and the changeover unit 14, it will cause a larger reaction force when the ratchet toothed block 13 meshes with the ratchet wheel head 12 in a state of applying force to idle toward an opposite direction. The ratchet toothed block 13 will press the pressing unit 141 downwards and the pressing unit 14 cannot compress timely owing to the reaction force, and that causes an idling angle of the ratchet wheel head 12 to be larger than an angle of one tooth, in other words, to be larger than 5 degrees. The idling angle can be re-controlled after the pressing unit 141 presses the ratchet toothed block 13 again. Hence, when executing an operation in a narrow room, an angle of applied force will be not as expected, and that will reduce the efficiency or increase a number of reciprocating rotation to further perplex the use.

### SUMMARY OF THIS INVENTION

This invention is to provide a resisting structure of ratchet wrench includes a main body, a ratchet wheel, an engagement unit, a changeover unit, and a moving unit. The main body has an accommodating groove, a curved groove, and a connecting groove. The curved groove is disposed between the connecting groove and the accommodating groove. The accommodating groove, the curved groove, and the connecting groove are in communication with one another. The ratchet wheel has a working portion located centrally. The ratchet wheel is pivotally disposed in the accommodating groove. A ratchet toothed portion fits an outer periphery of the ratchet wheel. The ratchet wheel is capable of rotating within the accommodating groove around the working portion as center. The engagement unit is disposed and accommodated in the curved groove and has an engagement toothed portion disposed on a front end surface of the engagement unit. The engagement toothed portion is capable of meshing with the ratchet toothed portion of the ratchet wheel. A changeover groove is disposed on a rear side of the engagement unit. A curved surface portion is disposed on two sides of the changeover groove respectively. The changeover unit is mounted in the connecting groove and located at the rear side of the engagement unit. The changeover unit has an assembling portion disposed on a front side of the changeover unit and situated at a place corresponding to the changeover groove which is located at the rear side of the engagement unit. A support portion is disposed on two sides of the assembling portion respectively and situated at a place corresponding to the curved surface portion. A space is formed between the support portion and the curved surface portion when the changeover unit rotates the support portion to allow the support portion to be near the curved surface portion. The space is 1˜1.2 times larger than a tooth height of the engagement toothed portion. The moving unit has a pressing portion and an elastic unit. The moving unit is disposed and accommodated in the assembling portion and capable of being in contact with the changeover groove elastically which is located at the rear side of the engagement unit.

In the resisting structure of the ratchet wrench provided by this invention, the support portion of the changeover unit can limit a distance caused when the engagement unit jumps away from the ratchet wheel to thereby allow the moving unit to provide the elasticity timely, ensure each idling angle of the ratchet wheel, ensure the rotation when the user operates in a narrow scope, and increase the operating efficiency.

Preferably, a limiting groove is disposed on an end surface of the connecting groove. A limiting side portion is disposed on two sides of the limiting groove respectively. A main block protrudes from an end surface of the changeover unit. The main block is disposed and accommodated in the limiting groove and capable of moving between the two limiting side portions.

Preferably, the limiting groove is disposed on a rear end surface of the connecting groove.

Preferably, a main hole penetrates through a bottom side of the connecting groove. The changeover unit has a pushing unit penetrating through the main hole and located at an outer side of the main body.

Preferably, an annular groove recesses around a periphery of the main hole and situated in coaxial relationship with the main hole. The changeover unit correspondingly has a positioning protruding block projecting outwards. The positioning protruding block is capable of rotating within the annular groove.

Preferably, a cover plate has a through hole and two positioning holes penetrating through the cover plate. The cover plate covers the accommodating groove, the curved groove, and the connecting groove. The working portion of the ratchet wheel penetrates through the through hole. A positioning unit is disposed on the end surface of the changeover unit and capable of being positioned in the positioning holes.

### BRIEF DESCRIPTION OF THE DRAWINGS

FIG. 1 is a perspective view showing a conventional ratchet wrench;

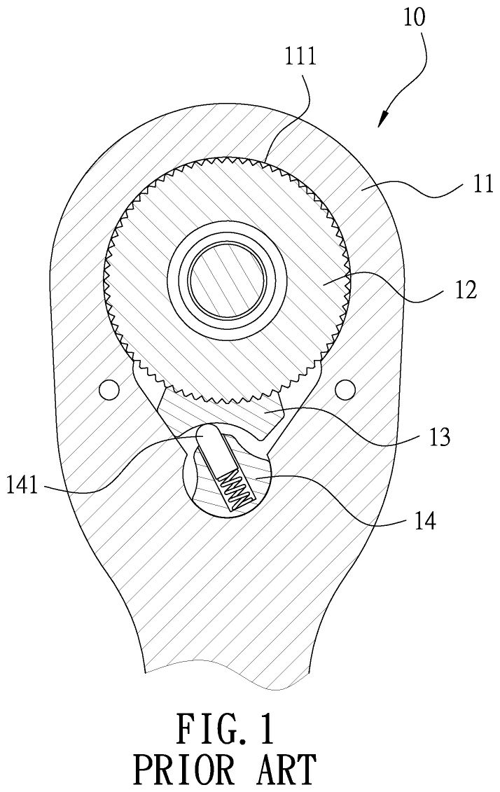

FIG. 2 is a perspective view showing a first preferred embodiment of this invention;

FIG. 3 is an exploded view showing the first preferred embodiment of this invention;

FIG. 4 is another exploded view showing the first preferred embodiment of this invention;

FIG. 5 is a schematic view showing the limiting groove of the main body meshes with the main block of the changeover unit;

FIG. 6 is a schematic view showing the engagement unit is pressed downwards when the ratchet wrench is idling;

FIG. 7 is a schematic view showing the annular groove located at the bottom side of the connecting groove meshes with the positioning protruding block of the changeover unit; and

FIG. 8 is a vertical cross-sectional view of the first preferred embodiment of this invention.

### DETAILED DESCRIPTION OF THE PREFERRED EMBODIMENTS

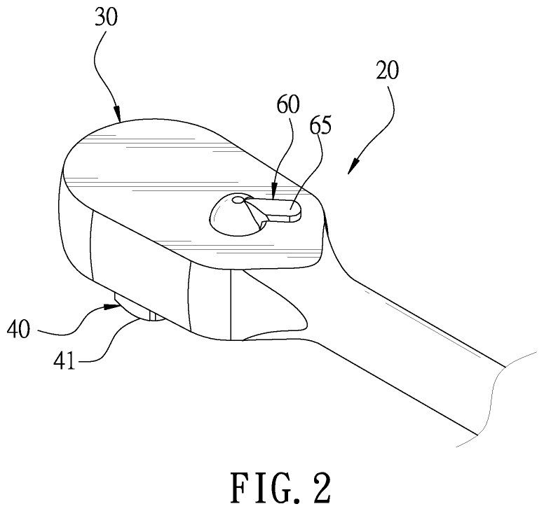

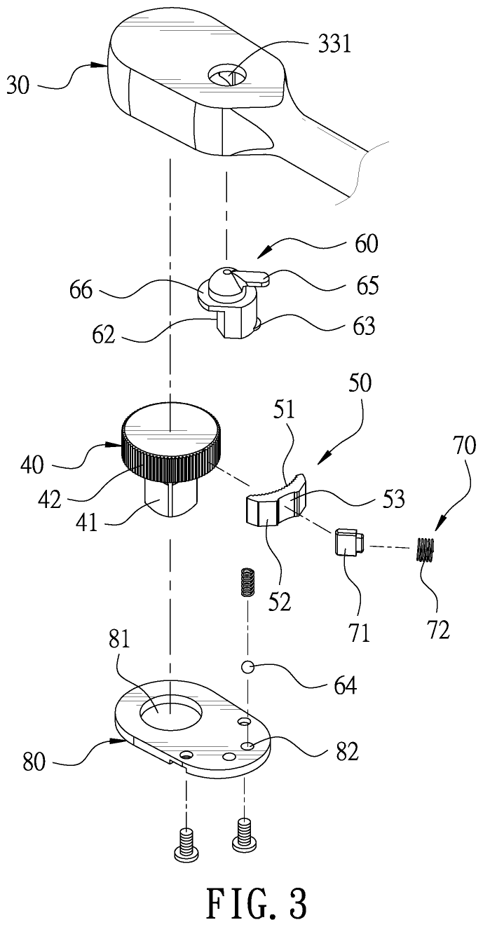

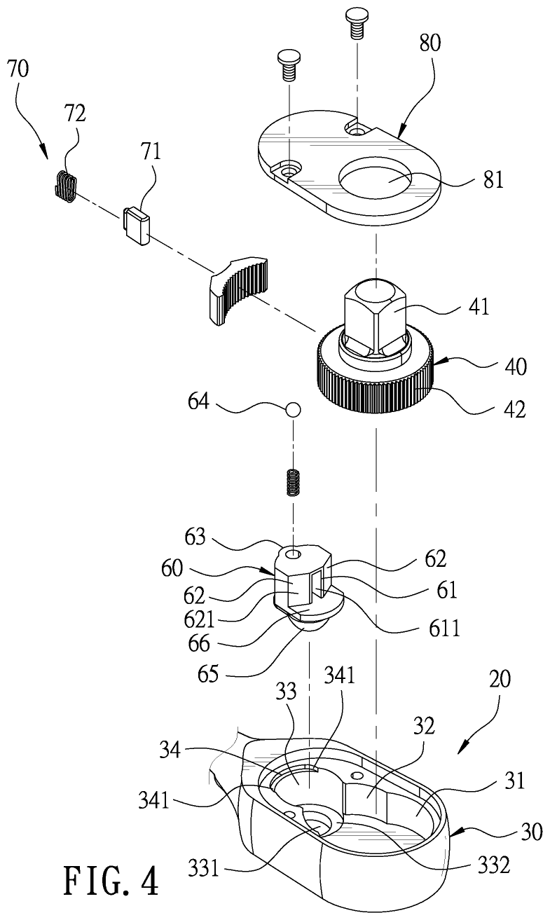

Referring to FIGS. 2 to 6, a resisting structure of ratchet wrench 20 of a first preferred embodiment of this invention comprises a main body 30, a ratchet wheel 40, an engagement unit 50, a changeover unit 60, a moving unit 70, and a cover plate 80.

The main body 30 has an accommodating groove 31, a curved groove 32, and a connecting groove 33 recessed on the main body 30 in sequence. The curved groove 32 is disposed between the connecting groove 33 and the accommodating groove 31. The accommodating groove 31, the curved groove 32, and the connecting groove 33 are in communication with one another. A limiting groove 34 is disposed on an end surface of the connecting groove 33 which is distant from the curved groove 32. A limiting side portion 341 is disposed on two sides of the limiting groove 34 respectively. A main hole 331 penetrates through a bottom side of the connecting groove 33. An annular groove 332 recesses around a periphery of the main hole 331 and situated in coaxial relationship with the main hole 331.

The ratchet wheel 40 has a working portion 41 located centrally. The ratchet wheel 40 is pivotally disposed in the accommodating groove 31. A ratchet toothed portion 42 fits an outer periphery of the ratchet wheel 40. The ratchet wheel 40 is capable of rotating within the accommodating groove 31 around the working portion 41 as center.

The engagement unit 50 is disposed and accommodated in the curved groove 32 and has an engagement toothed portion 51 disposed on a front end surface of the engagement unit 50. The engagement toothed portion 51 is capable of meshing with the ratchet toothed portion 42 of the ratchet wheel 40. A curved surface portion 52 is disposed on a rear side of the engagement unit 50. A changeover groove 53 is recessedly disposed on a center of the curved surface portion 52.

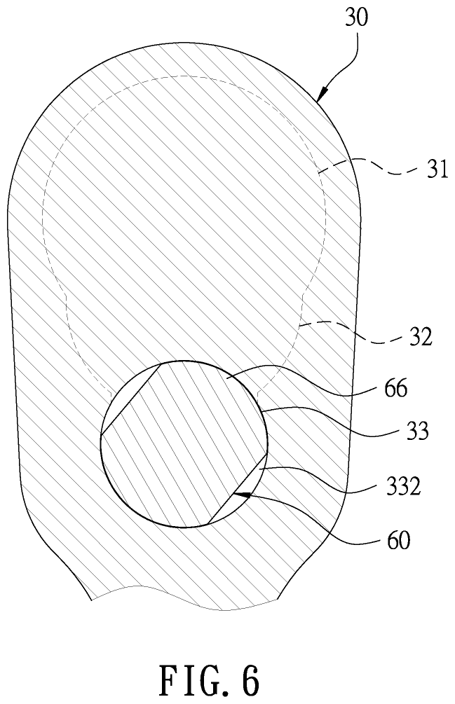

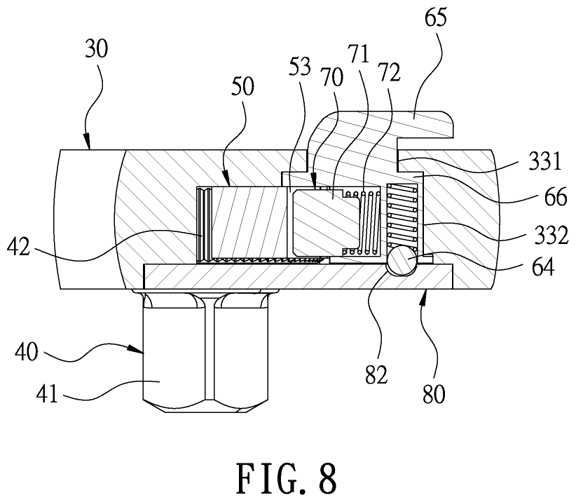

The changeover unit 60 is mounted in the connecting groove 33 and located at the rear side of the engagement unit 50. The changeover unit 60 has an assembling portion 61 disposed on a front side of the changeover unit 60 and situated at a place corresponding to the changeover groove 53 which is located at the rear side of the engagement unit 50. The assembling portion 61 is a recessed groove 611. A support portion 62 is formed at two sides of the assembling portion 61 respectively. The support portion 62 comprises a sloped surface 621 corresponding to the curved surface portion 52. A main block 63 protrudes from a top end surface of the changeover unit 60 and situated at a rear side of the changeover unit 60. The main block 63 is disposed and accommodated in the limiting groove 34 and capable of moving between the two limiting side portions 341. A positioning unit 64 is disposed on the top end surface of the changeover unit 60 and is provided with a round spheroid and a spring. A pushing unit 65 is disposed on a bottom side of the changeover unit 60. The pushing unit 65 penetrates through the main hole 331 and located at an outer side of the main body 30. Referring to FIG. 6 and FIG. 8, a positioning protruding block 66 projects outwards from the bottom side of the changeover unit 60. The positioning protruding block 66 is disposed in the annular groove 332 to thereby limit a rotating position of the changeover unit 60.

The moving unit 70 has a pressing portion 71 and an elastic unit 72. The moving unit 70 is disposed and accommodated in the recessed groove 611 of the assembling portion 61 and capable of being in contact with the changeover groove 53 elastically which is located at the rear side of the engagement unit 50.

The cover plate 80 has a through hole 81 and two positioning holes 82 penetrating through the cover plate 80 respectively. The cover plate 80 covers a top side of the main body 30 to thereby seal the accommodating groove 31, the curved groove 32, and the connecting groove 33. The working portion 41 of the ratchet wheel 40 penetrates through the through hole 81. The positioning unit 64 which is located at the top end surface of the changeover unit 60 can be positioned in the positioning holes 82 to achieve a positioning effect.

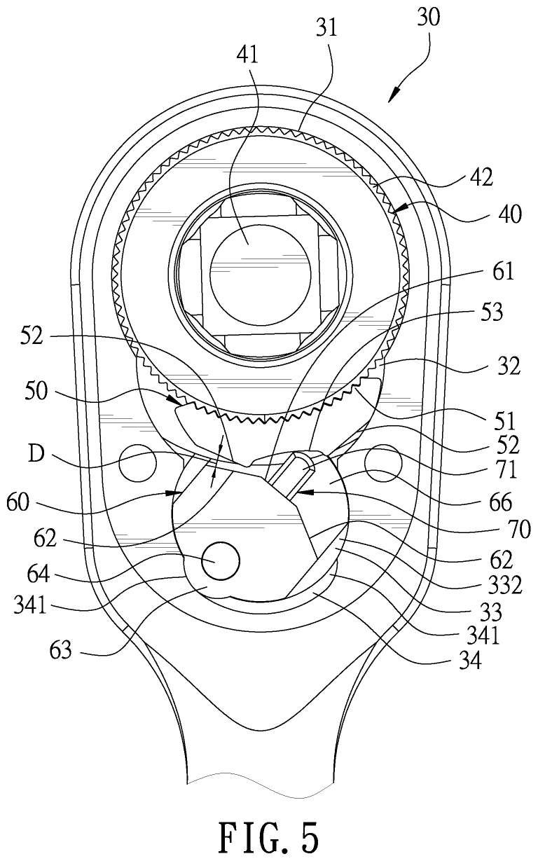

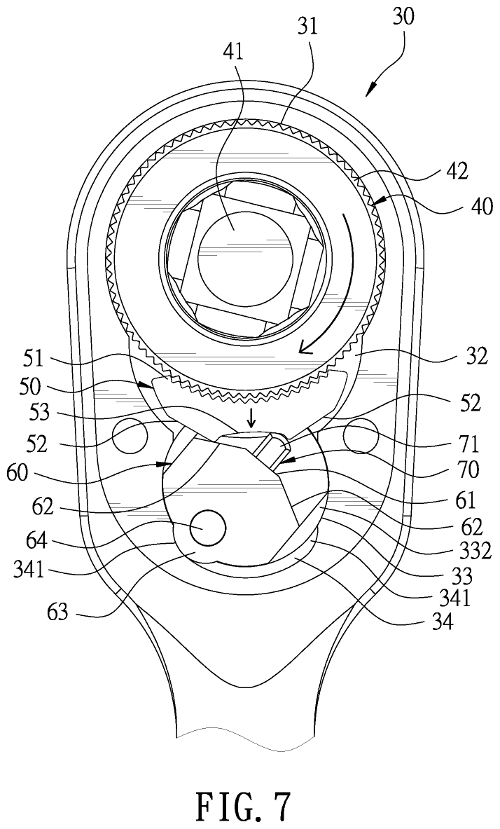

During an operation, referring to FIG. 5 and FIG. 7, the ratchet wrench 20 is operated by pushing the pushing unit 65 along the outer side of the main body 30 to thereby adjust a direction of the changeover unit 60. Because the main block 63 will change a position within the limiting groove 34 and be limited by the limiting side portions 341, the positioning unit 64 will be located in any one of the positioning holes 82 when the main block 63 presses any one of the limiting side portions 341, and that cause the user cannot keep moving the pushing unit 65 to thereby complete the change of operating direction. Because the limiting groove 34, the accommodating groove 31, the connecting groove 33, and the curved groove 32 are located on the same processing plane, it allows the limiting groove 34, the accommodating groove 31, the connecting groove 33, and the curved groove 32 to be processed simultaneously and reduces the processing process of the limiting groove 34. Moreover, the limiting groove 34 is covered by the cover plate 80, and that prevents the limiting groove 34 from exposing to the outside. Further, an operation of the pushing unit 65 along the outer side of the main body 30 will not be affected by any protrusion and the direction can be changed easily.

After the changeover unit 60 is positioned, the support portion 62 will be close to the curved surface portion 52 of the engagement unit 50. The space D between the support portion 62 and the curved surface portion 52 is 1˜1.2 times larger than a tooth height of the engagement toothed portion 51. Referring to FIG. 7, when the ratchet wheel 40 rotates against a direction of applied force, the ratchet wheel 40 will press the engagement unit 50 to allow the engagement unit 50 to move toward the changeover unit 60 and press the moving unit 70. The elastic unit 72 of the moving unit 70 is then compressed. Because the space D formed between the support portion 62 and the curved surface portion 52 is not large, a downward distance caused when the engagement unit 50 is pressed downwards will be limited. It will move back for a height of one tooth and cannot be pressed downwards anymore. Meanwhile, when the ratchet toothed portion 42 of the ratchet wheel 40 rotates for one tooth, the moving unit 70 can push the engagement unit 50 toward the ratchet wheel 40 immediately to thereby ensure an idling angle of the ratchet wheel 40 to rotate for one tooth each time, prevent the changeover unit 60 from being pressed unduly by the engagement unit 50, and prevent the idling angle from being over large and affect the operating efficiency.

The ratchet wrench of this invention takes advantages of the support portion of the changeover unit to limit the curved surface portion of the engagement unit when the ratchet wheel pushes the engagement unit toward the changeover unit to further limit a distance caused when the engagement unit jumps away and allow the moving unit to generate and provide the elasticity timely to the engagement unit to thereby ensure each idling angle of the ratchet wheel, ensure the rotation when the user operates in a narrow scope, and increase the operating efficiency.

Above disclosed embodiments are adapted to illustrate the technical means of this invention rather than limiting, it is understood that further variations and modifications with same effects may be made without departing from the scope of this invention. The hand tool of this invention has pioneering structure in this field and attains the enhancement of practical effect, the application is filed according to law.

1. A resisting structure of ratchet wrench comprising:
a main body having an accommodating groove, a curved groove, and a connecting groove, said curved groove being disposed between said connecting groove and said accommodating groove, said accommodating groove, said curved groove, and said connecting groove being in communication with one another;
a ratchet wheel having a working portion located centrally, said ratchet wheel being pivotally disposed in said accommodating groove, a ratchet toothed portion fitting an outer periphery of said ratchet wheel, said ratchet wheel being capable of rotating within said accommodating groove around said working portion as center; an engagement unit being disposed and accommodated in said curved groove and having an engagement toothed portion disposed on a front end surface of said engagement unit, said engagement toothed portion being capable of meshing with said ratchet toothed portion of said ratchet wheel, a changeover groove being disposed on a rear side of said engagement unit, a curved surface portion being disposed on two sides of said changeover groove respectively;
a changeover unit being mounted in said connecting groove and located at said rear side of said engagement unit, said changeover unit having an assembling portion disposed on a front side of said changeover unit and situated at a place corresponding to said changeover groove which is located at said rear side of said engagement unit, a support portion being disposed on two sides of said assembling portion respectively and comprising a sloped surface corresponding to said curved surface portion, a space being formed between said support portion and said curved surface portion when said changeover unit rotates said support portion to allow said support portion to be near said curved surface portion, said space being 1˜1.2 times larger than a tooth height of said engagement toothed portion, said support portion being configured to limit a downward distance of the curved surface portion of the engagement unit when the ratchet wheel pushes the engagement unit toward the changeover unit; and
a moving unit having a pressing portion and an elastic unit, said moving unit being disposed and accommodated in said assembling portion and capable of being in contact with said changeover groove elastically which is located at said rear side of said engagement unit.

2. The resisting structure of ratchet wrench according to claim 1, wherein a limiting groove is disposed on an end surface of said connecting groove, a limiting side portion being disposed on two sides of said limiting groove respectively, a main block protruding from an end surface of said changeover unit, said main block being disposed and accommodated in said limiting groove and capable of moving between said two limiting side portions.

3. The resisting structure of ratchet wrench according to claim 2, wherein said limiting groove is disposed on a rear end surface of said connecting groove.

4. The resisting structure of ratchet wrench according to claim 1, wherein a main hole penetrates through a bottom side of said connecting groove, said changeover unit having a pushing unit penetrating through said main hole and located at an outer side of said main body.

5. The resisting structure of ratchet wrench according to claim 4, wherein an annular groove recesses around a periphery of said main hole and situated in coaxial relationship with said main hole, said changeover unit correspondingly having a positioning protruding block projecting outwards, said positioning protruding block being capable of rotating within said annular groove.

6. The resisting structure of ratchet wrench according to claim 1, further comprising a cover plate, said cover plate having a through hole and two positioning holes penetrating through said cover plate, said cover plate covering said accommodating groove, said curved groove, and said connecting groove, said working portion of said ratchet wheel penetrating through said through hole, a positioning unit being disposed on said end surface of said changeover unit and capable of being positioned in said positioning holes.
